(19) United States
(12) Patent Application Publication
(10) Pub. No.: US 2026/0330354 A1
(43) Pub. Date: Oct. 22, 2026

(54) INFORMATION PROCESSING APPARATUS, INFORMATION PROCESSING METHOD, AND INFORMATION PROCESSING SYSTEM

(71) Applicant: Masaya OHTSU, Kanagawa (JP)

(72) Inventor: Masaya OHTSU, Kanagawa (JP)

(73) Assignee: Ricoh Company, Ltd., Tokyo (JP)

(21) Appl. No.: 19/468,275

(22) Filed: Feb. 3, 2026

(30) Foreign Application Priority Data
Mar. 19, 2025 (JP) 2025-044658

(51) Int. Cl. G06Q 10/0631

(52) U.S. Cl. CPC G06Q 10/06313; G06Q 10/063114

(57) ABSTRACT

An information processing apparatus includes circuitry. The circuitry receives an input of project information, identifies communication history information associated with a member participating in a project related to the received project information, sorts the identified communication history information based on an attribute of the member, acquires a work inference result indicating a work of the member inferred by a large language model with the sorted communication history information, and outputs the acquired work inference result in association with the attribute of the member.

### CROSS-REFERENCE TO RELATED APPLICATIONS

This patent application is based on and claims priority pursuant to 35 U.S.C. § 119(a) to Japanese Patent Application No. 2025-044658, filed on Mar. 19, 2025, in the Japan Patent Office, the entire disclosure of which is hereby incorporated by reference herein.

### BACKGROUND

### Technical Field

The present disclosure relates to an information processing apparatus, an information processing method, and an information processing system.

### Related Art

When multiple members participate in a project to perform certain works, a manager of the project normally checks information such as minutes of meetings held with the members participating in the project to grasp the works of the project.

There is a technique of generating a mind map, which is an example of an idea generation support diagram, based on words included in comments made by participants in a meeting. As an example using the technique, there is an information processing system that decomposes the text of comments by meeting participants into words and calculates the weighting factors of the degree of significance and the degree of relevance of each of the decomposed words to generate data in a mind map format (tree structure).

### SUMMARY

The present disclosure described herein provides an information processing apparatus that includes, for example, circuitry that receives an input of project information, identifies communication history information associated with a member participating in a project related to the received project information, sorts the identified communication history information based on an attribute of the member, acquires a work inference result indicating a work of the member inferred by a large language model with the sorted communication history information, and outputs the acquired work inference result in association with the attribute of the member.

The present disclosure described herein further provides an information processing method that includes, for example, receiving an input of project information, identifying communication history information associated with a member participating in a project related to the received project information, sorting the identified communication history information based on an attribute of the member, acquiring a work inference result indicating a work of the member inferred by a large language model with the sorted communication history information, and outputting the acquired work inference result in association with the attribute of the member.

The present disclosure described herein further provides an information processing system that includes, for example, an information processing apparatus and a terminal apparatus that communicates with the information processing apparatus via a network. The information processing apparatus includes first circuitry that receives an input of project information, identifies communication history information associated with a member participating in a project related to the received project information, sorts the identified communication history information based on an attribute of the member, acquires a work inference result indicating a work of the member inferred by a large language model with the sorted communication history information, and outputs the acquired work inference result in association with the attribute of the member. The terminal apparatus includes second circuitry that displays the work inference result on a display in association with the attribute of the member.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of an information processing system according to a first embodiment of the present disclosure;

FIG. 2 is a diagram illustrating an example of a hardware configuration of an information processing apparatus included in the information processing system of the first embodiment;

FIG. 3 is a diagram illustrating an example of a hardware configuration of a terminal apparatus included in the information processing system of the first embodiment;

FIG. 4 is a diagram illustrating functional configurations of apparatuses included in the information processing system of the first embodiment;

FIG. 5 is a table illustrating an example of a communication history storage unit of the information processing apparatus of the first embodiment;

FIG. 6 is a table illustrating an example of an attribute storage unit of the information processing apparatus of the first embodiment;

FIG. 7 is a sequence diagram illustrating an operation of the information processing system of the first embodiment;

FIGS. 8, 9, 10, and 11 are diagrams illustrating display examples of the terminal apparatus of the first embodiment;

FIG. 12 is a diagram illustrating a display example of the terminal apparatus according to a second embodiment of the present disclosure;

FIG. 13 is a diagram illustrating functional configurations of apparatuses included in the information processing system of the second embodiment;

FIG. 14 is a sequence diagram illustrating an operation of the information processing system of the second embodiment;

FIG. 15 is a diagram illustrating another display example of the terminal apparatus of the second embodiment;

FIG. 16 is a table illustrating an example of the communication history storage unit according to a third embodiment of the present disclosure; and

FIG. 17 is a diagram illustrating a display example of the terminal apparatus of the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

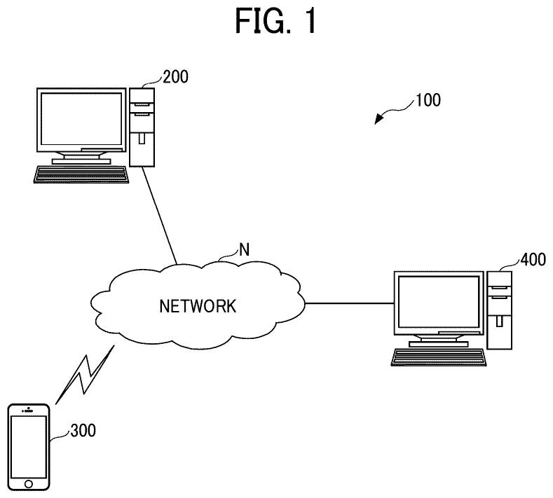

FIG. 1 is a diagram illustrating an example of the system configuration of an information processing system 100 according to a first embodiment of the present disclosure.

The information processing system 100 includes an information processing apparatus 200 and a terminal apparatus 300. In the information processing system 100, the information processing apparatus 200 and the terminal apparatus 300 are communicably connected to each other via a network N. The information processing apparatus 200 communicates with a server apparatus 400 via the network N.

In the first embodiment, the network N may be a wide-area network such as the Internet or a wide area network (WAN), a local area network (LAN), a network using a technology such as wireless fidelity (Wi-Fi®) or wide-area Ethernet®, or a mobile phone network using a technology such as fourth generation (4G), fifth generation (5G), or sixth generation (6G), for example.

The server apparatus 400, which includes a large language model (LLM), implements generative artificial intelligence (AI). The generative AI generates text data in accordance with an input prompt and outputs the text data to the information processing apparatus 200, as in chat generative pre-trained transformer (ChatGPT), for example. In the first embodiment, the prompt refers to text data for expressing an instruction or question to the generative AI implemented by the server apparatus 400. Details of the LLM will be described later.

It suffices if the information processing system 100 includes the information processing apparatus 200 and the terminal apparatus 300; the information processing system 100 may or may not include the server apparatus 400.

The information processing system 100 is introduced to an organization such as a company to support the progress management of works in the organization, for example. In the first embodiment, the organization refers to an organization to which a service provided by the information processing system 100 is introduced, and which includes a plurality of departments that perform various types of work, for example. People belonging to the organization are assigned to the departments.

In the first embodiment, a collection of works performed by a plurality of people from different groups (affiliations) will be referred to as a project, and a plurality of people participating in performing the works will be referred to as the members participating in the project.

In the information processing system 100, the terminal apparatus 300 is used mainly by a manager in charge of tasks such as the progress management of the project. A user of the terminal apparatus 300 is an example of a project manager (the manager of the project) in charge of tasks such as the progress management of the project.

In the information processing system 100, the information processing apparatus 200 generates a mind map related to the project and causes the terminal apparatus 300 to display the generated mind map.

In the first embodiment, the mind map is an example of an idea generation support diagram, which is a diagram expressing ideas envisioned in human minds. The mind map is used to support the improvement of idea generation, writing, and communication abilities, and is expressed as a two-dimensional diagram linking various items, for example.

The information processing apparatus 200 stores attribute information and communication history information. The attribute information indicates attributes of the people belonging to the organization. The communication history information indicates a history of communication between the people belonging to the organization.

The attribute information, which is information indicating the attributes of the people belonging to the organization, includes a plurality of items indicating the attributes of the people. For example, the attribute information includes, but is not limited to, the group, the type of work, and the date of employment.

The communication history information is information indicating a history of information sharing between the people belonging to the organization. The communication history information is associated with one or more members participating in the project. The communication history information includes, but is not limited to, information indicating a history of communication.

In response to input of information related to the project from the terminal apparatus 300, the information processing apparatus 200 sorts communication history information related to the project based on the attributes of members involved in communication by using the communication history information and the attribute information of the members. With the communication history information sorted based on the attributes of the members, the information processing apparatus 200 then causes the server apparatus 400 to infer works based on the attributes of the members. The information processing apparatus 200 further causes the server apparatus 400 to associate the inferred works with the communication history information.

In the first embodiment, the attributes of the members participating in the project, the inferred works, and the communication history information are associated with each other through the above-described process. Based on this association, the information processing apparatus 200 generates a mind map that sorts the communication history information by the combination of the attributes of the members and the inferred works, and causes the terminal apparatus 300 to display the mind map.

The first embodiment, therefore, enables the project manager to grasp the attributes of the members and the works associated with the communication history information. The first embodiment further enables the project manager to readily understand the progress of each of the works included in the project and the ideas and thoughts of the members in charge of the works, for example. Consequently, the first embodiment facilitates the understanding of the progress of the project (works).

In the example of FIG. 1, the information processing apparatus 200 and the terminal apparatus 300 are configured as separate apparatuses. However, the information processing apparatus 200 and the terminal apparatus 300 are not limited to this configuration. The information processing apparatus 200 may also function as the terminal apparatus 300. Similarly, the information processing apparatus 200 and the server apparatus 400 are configured as separate apparatuses in the example of FIG. 1, but are not limited to this configuration. The server apparatus 400 may be included in the information processing apparatus 200.

In FIG. 1, the information processing apparatus 200 is implemented by one or more information processing apparatuses; the information processing apparatus 200 may be implemented by a plurality of information processing apparatuses.

An example of hardware configurations of the apparatuses included in the information processing system 100 will be described.

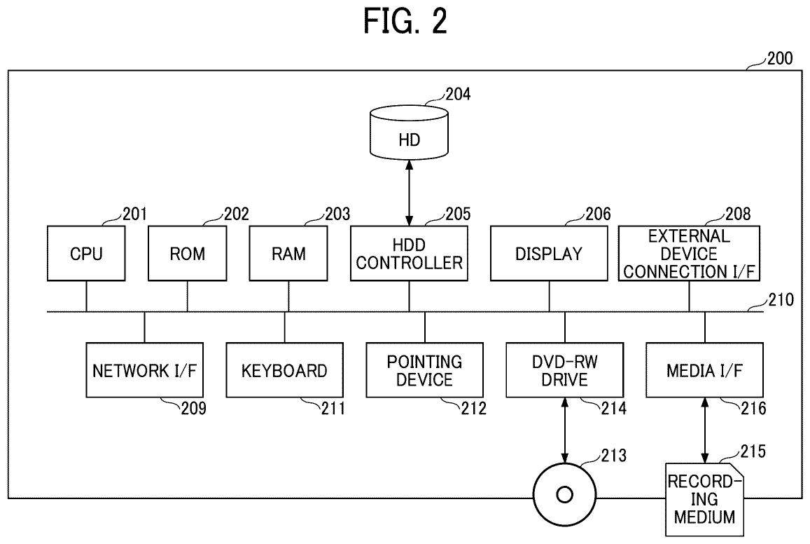

FIG. 2 is a diagram illustrating an example of the hardware configuration of the information processing apparatus 200. The information processing apparatus 200 illustrated in FIG. 2 is implemented by a computer (information processing apparatus). As illustrated in FIG. 2, the information processing apparatus 200 includes a central processing unit (CPU) 201, a read-only memory (ROM) 202, a random-access memory (RAM) 203, a hard disk (HD) 204, a hard disk drive (HDD) controller 205, a display 206, an external device connection interface (I/F) 208, a network I/F 209, a bus line 210, a keyboard 211, a pointing device 212, a digital versatile disc-rewritable (DVD-RW) drive 214, and a media I/F 216.

The CPU 201 controls overall operation of the information processing apparatus 200. The ROM 202 stores a program used to drive the CPU 201 such as an initial program loader (IPL). The RAM 203 is used as a work area for the CPU 201. The HD 204 stores various data such as programs. The HDD controller 205 controls the writing or reading of various data to or from the HD 204 under the control of the CPU 201. The display 206 displays various information such as a cursor, menus, windows, text, and images. The external device connection I/F 208 is an interface for connecting various external devices to the information processing apparatus 200. The external devices in this case include a universal serial bus (USB) memory and a printer, for example. The network I/F 209 is an interface for performing data communication via a communication network. The bus line 210 includes address buses and data buses for electrically connecting the CPU 201 and the other components in FIG. 2 to each other.

The keyboard 211 is an example of input means including a plurality of keys for inputting text, numerical values, and various instructions, for example. The pointing device 212 is an example of input means for selecting and executing various instructions, selecting a processing target, and moving the cursor, for example. The DVD-RW drive 214 controls the writing or reading of various data to or from a DVD-RW 213, which is an example of a removable recording medium. The removable recording medium is not limited to the DVD-RW, and may be a DVD-recordable (DVD-R), for example. The media I/F 216 controls the writing (storage) or reading of data to or from a recording medium 215 such as a flash memory.

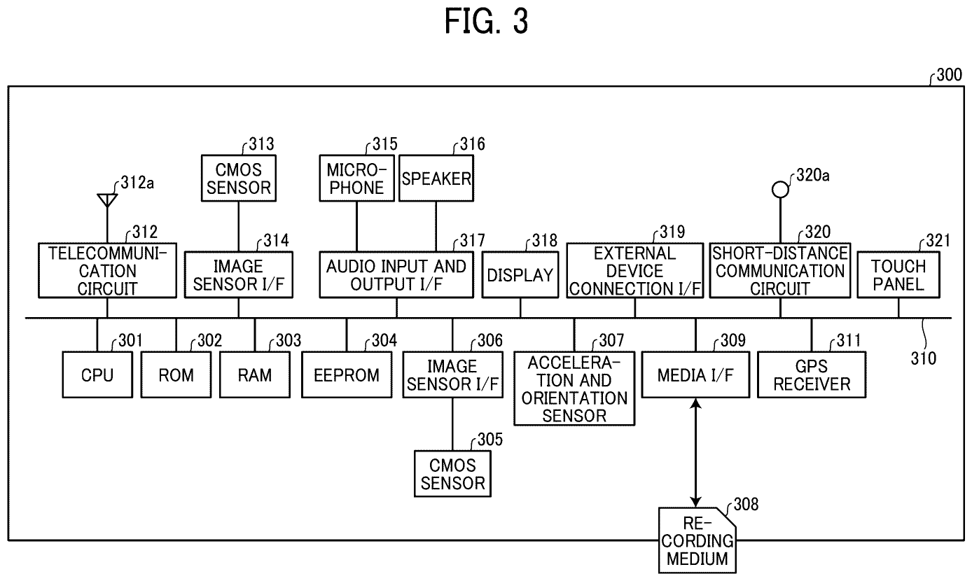

FIG. 3 is a diagram illustrating an example of the hardware configuration of the terminal apparatus 300 of the first embodiment. The terminal apparatus 300 includes a CPU 301, a ROM 302, a RAM 303, an electrically erasable programmable read-only memory (EEPROM) 304, a complementary metal-oxide semiconductor (CMOS) sensor 305, an image sensor I/F 306, an acceleration and orientation sensor 307, a media I/F 309, and a global positioning system (GPS) receiver 311.

The CPU 301 is an arithmetic processing device that controls overall operation of the terminal apparatus 300. The ROM 302 stores a program used to drive the CPU 301 such as an IPL. The RAM 303 is used as a work area for the CPU 301. The EEPROM 304 writes or reads various data such as smartphone programs under the control of the CPU 301. The ROM 302, the RAM 303, and the EEPROM 304 are examples of a storage device of the terminal apparatus 300.

The CMOS sensor 305 is an example of built-in imaging means for capturing the image of a subject (mainly the image of a user) under the control of the CPU 301 to obtain image data. The imaging means may be a charge-coupled device (CCD) sensor, for example, in place of the CMOS sensor.

The image sensor I/F 306 is a circuit that controls the driving of the CMOS sensor 305. The acceleration and orientation sensor 307 includes various sensors such as an electromagnetic compass that detects geomagnetism, a gyrocompass, and an acceleration sensor. The media I/F 309 controls the writing (storage) or reading of data to or from a recording medium 308 such as a flash memory. The GPS receiver 311 receives GPS signals from GPS satellites.

The terminal apparatus 300 further includes a telecommunication circuit 312, an antenna 312a for the telecommunication circuit 312, a CMOS sensor 313, an image sensor I/F 314, a microphone 315, a speaker 316, an audio input and output I/F 317, a display 318, an external device connection I/F 319, a short-distance communication circuit 320, an antenna 320a for the short-distance communication circuit 320, and a touch panel 321.

The telecommunication circuit 312 is a circuit that communicates with another apparatus via a communication network. The CMOS sensor 313 is an example of built-in imaging means for capturing the image of a subject under the control of the CPU 301 to obtain image data. The image sensor I/F 314 is a circuit that controls the driving of the CMOS sensor 313. The microphone 315 is a built-in circuit that converts sound into electrical signals. The speaker 316 is a built-in circuit that converts electrical signals into physical vibration to produce the sound of music or voice, for example. The audio input and output I/F 317 is a circuit that processes the input of audio signals to the microphone 315 and the output of audio signals from the speaker 316 under the control of the CPU 301.

The display 318 is an example of display means such as a liquid crystal or organic electroluminescence (EL) display for displaying the image of a subject, various icons, and so forth. The external device connection I/F 319 is an interface for connecting various external devices to the terminal apparatus 300. The short-distance communication circuit 320 is a communication circuit conforming to a standard such as near field communication (NFC) or Bluetooth®. The touch panel 321 is an example of input means for the user to operate the terminal apparatus 300 by pressing the display 318. The display 318 is an example of a display unit included in the terminal apparatus 300.

The hardware configuration illustrated in FIG. 3 is an exemplary hardware configuration of the terminal apparatus 300. The hardware configuration of the terminal apparatus 300 is not limited thereto, and may be the hardware configuration illustrated in FIG. 2.

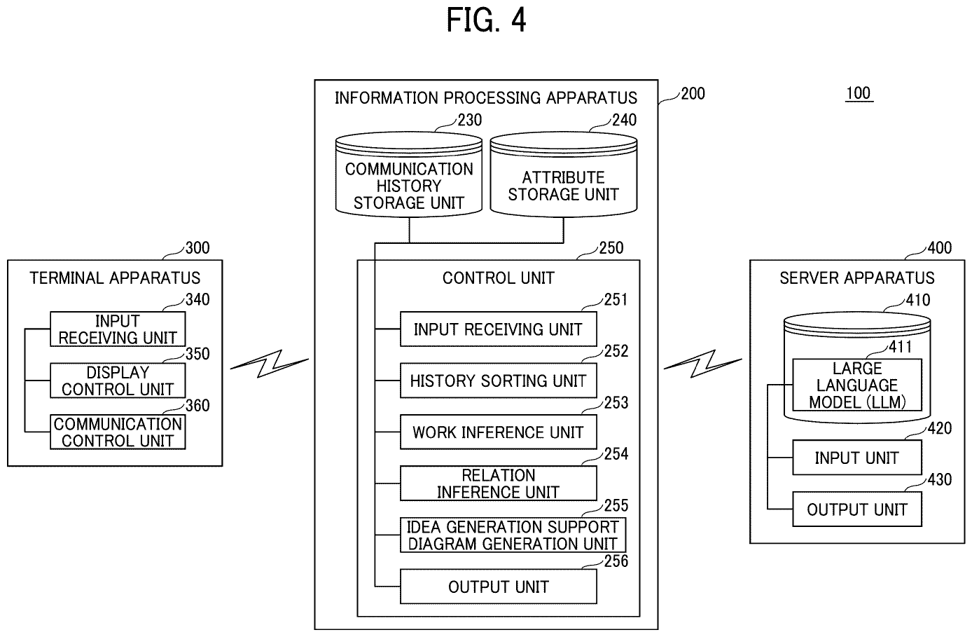

Functional configurations of the apparatuses included in the information processing system 100 will be described with reference to FIG. 4. FIG. 4 is a diagram illustrating functional configurations of the apparatuses included in the information processing system 100 of the first embodiment.

A functional configuration of the information processing apparatus 200 will be described first.

The information processing apparatus 200 includes a communication history storage unit 230, an attribute storage unit 240, and a control unit 250. The communication history storage unit 230 and the attribute storage unit 240 are implemented by a storage device such as the HD 204 of the information processing apparatus 200. The control unit 250 is implemented by the CPU 201 of the information processing apparatus 200 reading and executing a program stored in a storage device such as the HD 204.

The communication history storage unit 230 stores the communication history information. The communication history information includes communication information indicating the contents of communication and information identifying a member who has sent the communication information.

The communication information includes a minute of a meeting held in relation to the project, a report prepared by a member participating in the project, the information of a history of chat exchanged between members participating in the project, and electronic mails (emails) transmitted and received between members participating in the project, for example. The communication history information may also include information indicating a history of communication between a member participating in the project and a person not participating in the project.

The member who has sent the communication information may be a member who has made a comment in a meeting, has sent a chat message in a chat, or has sent an email, for example. A member who has shared information may be a member who has attended the meeting, for example. In the following description, a member who has sent the communication information will be referred to as the sender.

The attribute storage unit 240 stores the attribute information. The attribute information is information in which information identifying a member belonging to the organization, information indicating a group in the organization to which the member is assigned, and the type of work in which the member is engaged, for example, are associated with each other.

The communication history storage unit 230 and the attribute storage unit 240 are provided for each organization to which the information processing system 100 is introduced. Details of the communication history storage unit 230 and the attribute storage unit 240 will be described later.

The control unit 250 includes an input receiving unit 251, a history sorting unit 252, a work inference unit 253, a relation inference unit 254, an idea generation support diagram generation unit 255, and an output unit 256.

The input receiving unit 251 receives the input of various information to the information processing apparatus 200. Specifically, the input receiving unit 251 receives the input of project information related to the project. The project information includes information describing the contents of the project, the name of the project, and information identifying the members participating in the project, for example.

Based on the input project information, the history sorting unit 252 extracts the communication history information related to the project from the communication history storage unit 230, and sorts the extracted communication history information based on the attribute of the sender.

The work inference unit 253 acquires the inferred work of the sender based on the attribute information of the sender included in the extracted communication history information. Specifically, the work inference unit 253 causes the server apparatus 400 to infer the work name indicating the work of the sender.

The work inference unit 253 generates a prompt requesting to infer the work name based on the attribute information of the sender, and transmits the generated prompt to the server apparatus 400.

The work inference unit 253 then acquires the inferred work name output from the server apparatus 400. In the following description, information indicating the inferred work name corresponding to the attribute of the sender will be referred to as the work information. The work information is information that associates the attribute of the sender with the work name indicating the work inferred based on the attribute of the sender.

In other words, the work name inferred by the server apparatus 400 corresponds to the attribute of the sender inferred by a large language model (LLM) 411.

The relation inference unit 254 acquires association information that indicates the result of associating the extracted communication history information with the work information in accordance with the relation therebetween. Specifically, the relation inference unit 254 generates a prompt requesting to associate the communication history information with the work information, and transmits the generated prompt to the server apparatus 400. The relation inference unit 254 then acquires response data output from the server apparatus 400 as the association information indicating the association between the communication history information and the work information.

Based on the extracted communication history information, the attribute information of the sender, and the association information, the idea generation support diagram generation unit 255 generates mind map information representing a mind map. The mind map information is an example of information representing an idea generation support diagram.

The idea generation support diagram generation unit 255 generates mind map information that sorts the communication history information by the attribute of the sender indicated by the attribute information and the work name inferred by the server apparatus 400. In other words, the idea generation support diagram generation unit 255 generates mind map information that sorts the communication history information by the combination of a previously set attribute of the sender and an attribute of the sender inferred by the LLM 411.

In the following description of the first embodiment, the previously set attribute of the sender may be referred to as the first attribute, and the attribute of the sender different from the first attribute and inferred by the LLM 411 based on the first attribute may be referred to as the second attribute.

The output unit 256 outputs various information to an external apparatus from the information processing apparatus 200. Specifically, the output unit 256 outputs a prompt to the server apparatus 400, for example. The output unit 256 further outputs the mind map information to the terminal apparatus 300.

In the example of FIG. 4, the information processing apparatus 200 includes the communication history storage unit 230 and the attribute storage unit 240. However, the configuration is not limited thereto. Each of the communication history storage unit 230 and the attribute storage unit 240 may be partially or entirely provided in an external apparatus that is communicable with the information processing apparatus 200. Further, in the example of FIG. 4, the information processing apparatus 200 includes the control unit 250. However, the configuration is not limited thereto. The functions of the control unit 250 may be implemented by a plurality of information processing apparatuses. In other words, the functions of the information processing apparatus 200 may be implemented by a plurality of information processing apparatuses.

Functions of the terminal apparatus 300 will be described.

The terminal apparatus 300 includes an input receiving unit 340, a display control unit 350, and a communication control unit 360. The input receiving unit 340 receives an input to the terminal apparatus 300. The display control unit 350 controls the display on the terminal apparatus 300. The communication control unit 360 controls the communication of the terminal apparatus 300 with the information processing apparatus 200.

The input receiving unit 340, the display control unit 350, and the communication control unit 360 may be implemented by a world wide web (web) browser used by the terminal apparatus 300, or may be implemented by other means than the web browser.

The server apparatus 400 includes an LLM storage unit 410, an input unit 420, and an output unit 430. The LLM storage unit 410 stores the LLM 411 that implements generative AI.

The LLM 411 is a computer language model generated through a learning process with vast unlabeled text as learning data and formed with an artificial neural network with a multitude of parameters. The LLM 411 understands many of the sentence structures and word meanings of a human language through adequate training with methods for leaning context such as next sentence prediction and a masked language model, for example. The next sentence prediction determines whether two sentences are next to each other to understand context. The masked language model predicts a masked word in text based on preceding and following words to understand context.

The input unit 420 inputs a prompt transmitted from the information processing apparatus 200 to the LLM 411. The output unit 430 outputs (transmits) data from the LLM 411 to the information processing apparatus 200. In other words, the output unit 430 transmits to the information processing apparatus 200 the response data to the prompt, which is output from the LLM 411.

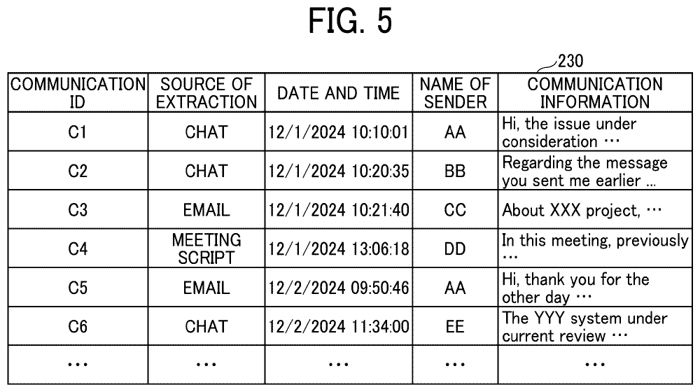

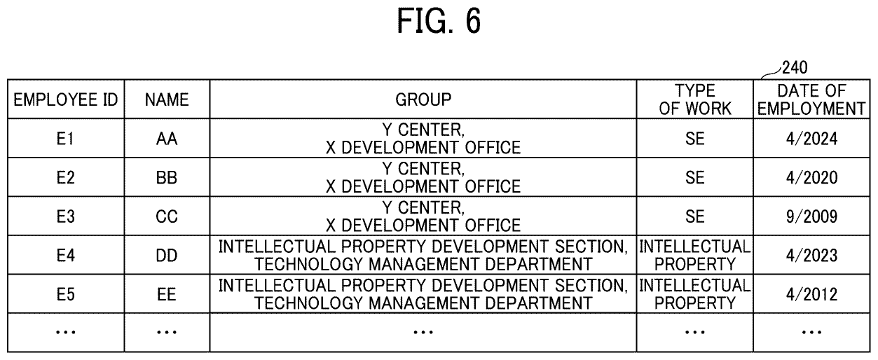

The storage units of the information processing apparatus 200 will be described with reference to FIGS. 5 and 6. FIG. 5 is a table illustrating an example of the communication history storage unit 230 of the first embodiment.

The communication history information stored in the communication history storage unit 230 includes information items such as “communication identifier (ID),” “source of extraction,” “date and time,” “name of sender,” and “communication information.” The item “communication ID” is associated with the other items.

The value of the item “communication ID” is identification information for identifying a record of communication history information. The value of the item “source of extraction” indicates the source of extraction of the communication information. In other words, the value of the item “source of extraction” is information identifying the method used for the communication.

The value of the item “date and time” indicates the date and time of the communication, i.e., the date and time of transmission of the communication information. The value of the item “name of sender” is information identifying the member who has sent the communication information. In the first embodiment, the name of the member is used as the information identifying the member.

The example of FIG. 5 indicates that, in communication history information identified by a communication ID “C1,” a member with a name “AA” has sent a message “Hi, the issue under consideration . . . ” in a chat at 10:10:01 on Dec. 1, 2024.

The information items included in the communication history information are not limited to those illustrated in FIG. 5. The communication history information may include an item other than those illustrated in FIG. 5. Further, it suffices if the communication history information includes the sender, the communication information, and the date and time; the communication history information may not include all items illustrated in FIG. 5.

FIG. 6 is a table illustrating an example of the attribute storage unit 240 of the first embodiment. The attribute information stored in the attribute storage unit 240 includes information items such as “employee ID,” “name,” “group,” “type of work,” and “date of employment.” The item “employee ID” is associated with the other items.

The value of the item “employee ID” is identification information for identifying a member belonging to the organization. The value of the item “name” indicates the name of the member, and the value of the item “group” indicates the department or the like (group) to which the member is assigned. In other words, the value of the item “group” indicates the group of the member. The value of the item “type of work” indicates the type of work in which the member is engaged. The value of the item “date of employment” indicates the date of employment of the member.

The example of FIG. 6 indicates that the member with the name “AA,” who is identified by an employee ID “E1” and employed in April 2024, is assigned to Y Center of X Development Office and engaged in a work indicated as “system engineering (SE)” in the item “type of work.”

The information items included in the attribute information are not limited to those illustrated in FIG. 6. The attribute information may include an item other than those illustrated in FIG. 6. Further, it suffices if the attribute information includes information indicating the organization of the member; the attribute information may not include all items illustrated in FIG. 6.

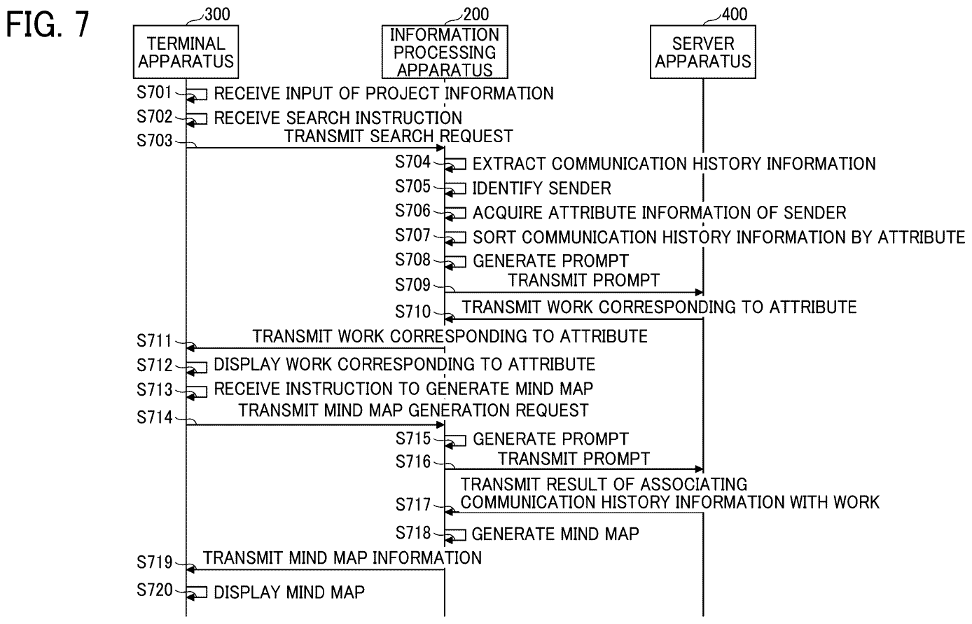

An operation of the information processing system 100 will be described with reference to FIG. 7. FIG. 7 is a sequence diagram illustrating an operation of the information processing system 100.

In the information processing system 100, the terminal apparatus 300 receives the input of the project information with the input receiving unit 340 (step S701). In this process, an input screen for inputting the project information is displayed on the display 318 of the terminal apparatus 300. The project information is input via the input screen of the project information.

More specifically, a project name, a description of the contents of the project, the members participating in the project, a project starting date, and so forth are input on the input screen of the project information. Details of the input screen of the project information will be described later.

The terminal apparatus 300 then receives an operation of issuing an instruction to perform a search through the communication history storage unit 230 based on the project information (step S702). With the communication control unit 360, the terminal apparatus 300 transmits a search request including the project information to the information processing apparatus 200 (step S703).

In the example of FIG. 7, the terminal apparatus 300 receives the input of the project information. However, the acquisition of the project information is not limited to this example. The project information may be previously stored in the information processing apparatus 200, and the terminal apparatus 300 may read the stored project information from the information processing apparatus 200.

In the information processing apparatus 200, the input receiving unit 251 receives from the terminal apparatus 300 the search request including the project information. Then, the history sorting unit 252 performs a search through the communication history storage unit 230 with the project information, identifies communication history information related to the project, and extracts the identified communication history information (step S704). For example, the history sorting unit 252 identifies and extracts communication information including the same words as a project name “Project Z” included in the input project information. Alternatively, the history sorting unit 252 may identify and extract communication information including the name of the sender identical to the project member “AA” or “BB” included in the input project information. The history sorting unit 252 functions as an identification unit that identifies the communication history information related to the input project information. The history sorting unit 252 further functions as an extraction unit that extracts the communication history information related to the input project information.

The history sorting unit 252 of the information processing apparatus 200 then identifies the sender of the communication information included in the extracted communication history information (step S705). With reference to the attribute storage unit 240, the history sorting unit 252 acquires the attribute information of the identified sender (step S706).

Then, the history sorting unit 252 sorts the communication history information extracted at step S704 based on the attribute of the sender indicated by the attribute information of the sender (step S707).

In the first embodiment, the value of the item “group” included in the attribute information is the previously set attribute of the sender. In other words, the value of the item “group” in the attribute information of the first embodiment is an example of the first attribute.

At step S707, therefore, the communication history information is sorted by the group of the sender. In the following description, the communication history information sorted by the group of the sender will be referred to as the sorted information. That is, the sorted information of the first embodiment is information that associates the communication history information with the group of the sender (the first attribute). The sorted information is temporarily held in the information processing apparatus 200 until the mind map information is generated. Alternatively, the sorted information may be permanently held in the information processing apparatus 200.

The information item used as the first attribute of the sender is not limited to “group.” It suffices if the item used as the first attribute of the sender is included in the attribute information stored in the attribute storage unit 240, such as the item “type of work” or “date of employment,” for example. The item used as the first attribute of the sender may be set as desired by the project manager.

The history sorting unit 252 generates, for each sorted information, a prompt requesting to infer the work in the communication history information included in the sorted information (step S708). The prompt generated by the history sorting unit 252 is a prompt requesting the sorted information and the inference of the work based on the sorted information, for example.

The history sorting unit 252 then outputs the prompt generated at step S708 to the server apparatus 400 (step S709).

The history sorting unit 252 of the information processing apparatus 200 acquires from the server apparatus 400 work information indicating the inferred work for each sorted information (step S710). In other words, the information processing apparatus 200 acquires from the server apparatus 400 information that associates the group of the sender with the work name indicating the work of the group of the sender.

In the server apparatus 400, in response to receipt of the prompt generated by the history sorting unit 252, the input unit 420 inputs the prompt to the LLM 411, and the output unit 430 transmits response data output from the LLM 411 to the information processing apparatus 200. The history soring unit 252 of the information processing apparatus 200 acquires the response data from the server apparatus 400 as the work information.

The work name inferred by the LLM 411 is an example of the second attribute of the sender.

In the information processing apparatus 200, the output unit 256 outputs the work information corresponding to the attribute to the terminal apparatus 300 (step S711). In other words, the information processing apparatus 200 outputs screen information for causing the terminal apparatus 300 to display a screen including information that associates the group of the sender (the first attribute) with the work name indicating the work of the group of the sender (the second attribute).

In the terminal apparatus 300, in response to receipt of the work information, the display control unit 350 causes the display 318 to display a check screen for the user of the terminal apparatus 300 to check the work name of each group (step S712).

In the terminal apparatus 300, the input receiving unit 340 receives, via the check screen displayed at step S712, an operation of issuing an instruction to generate a mind map (step S713), and the communication control unit 360 transmits a mind map generation request to the information processing apparatus 200 (step S714).

In the information processing apparatus 200, the input receiving unit 251 receives the mind map generation request, and the relation inference unit 254 generates a prompt requesting to associate the communication history information extracted at step S704 with the work information acquired at step S710 (step S715).

The prompt generated by the relation inference unit 254 includes the communication history information extracted at step S704 and the work information acquired at step S710, for example. The prompt generated by the relation inference unit 254 is a prompt requesting to associate the communication history information with the work information inferred to be highly related to the communication history information based on the degree of semantic similarity or the degree of lexical similarity.

The relation inference unit 254 then outputs the generated prompt to the server apparatus 400 (step S716).

The relation inference unit 254 of the information processing apparatus 200 acquires from the server apparatus 400 association information indicating the result of associating the communication history information with the work information (step S717).

In the server apparatus 400, in response to receipt of the prompt generated by the relation inference unit 254, the input unit 420 inputs the prompt to the LLM 411, and the output unit 430 transmits response data output from the LLM 411 to the information processing apparatus 200. The information processing apparatus 200 acquires the response data from the server apparatus 400 as the association information.

The first embodiment uses the server apparatus 400 for the association of the communication history information with the work information by the relation inference unit 254. However, the association of the communication history information with the work information is not limited thereto, and may be performed with a method of calculating the degree of similarity such as cosine similarity or Levenshtein distance. In this case, the relation inference unit 254 may calculate the degree of similarity between the communication history information and the work information and associate the communication history information with the work information based on the calculated degree of similarity.

In the information processing apparatus 200, with reference to the communication history information, the attribute information of the sender who has sent the communication information, and the association information, the idea generation support diagram generation unit 255 generates mind map information representing a mind map (step S718). The mind map information generated here represents a mind map that sorts the communication history information in accordance with the combination of the group of the sender and the work.

In the information processing apparatus 200, the output unit 256 then outputs the mind map information to the terminal apparatus 300 (step S719). In the terminal apparatus 300, the communication control unit 360 receives the mind map information, and the display control unit 350 causes the display 318 to display the mind map information (step S720).

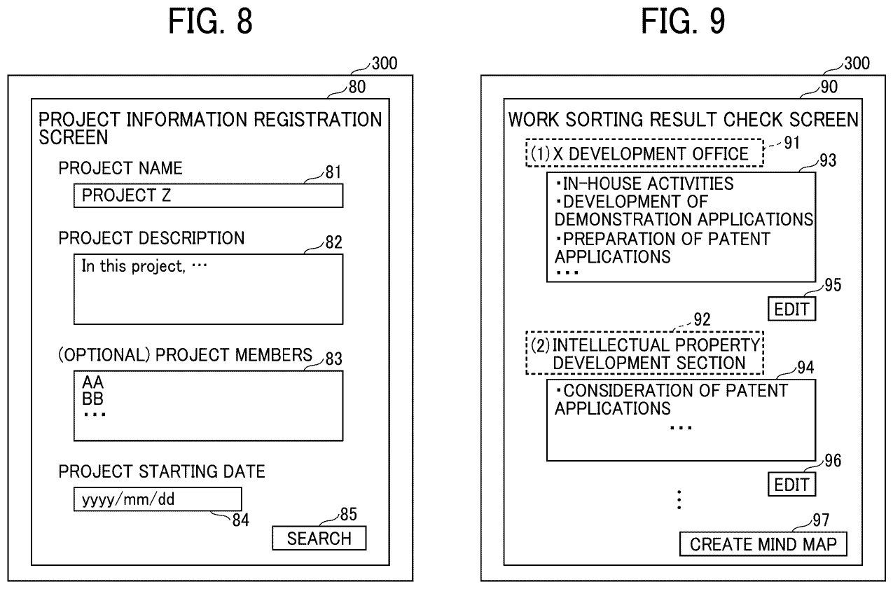

Display examples of the terminal apparatus 300 will be described with reference to FIGS. 8, 9, 10, and 11.

FIG. 8 is a diagram illustrating a display example of the terminal apparatus 300 of the first embodiment. A screen 80 illustrated in FIG. 8 is an example of the input screen of the project information displayed on the terminal apparatus 300 at step S701 in FIG. 7.

The screen 80 includes input fields 81, 82, 83, and 84 and an operation button 85. The input field 81 is for inputting the project name. The input field 82 is for inputting a description of the contents of the project. The input field 83 is for inputting the members participating in the project. The input field 84 is for inputting the starting date of the project.

The operation button 85 is for issuing an instruction to perform a search through the communication history storage unit 230 with the project information, i.e., to execute a process of causing the terminal apparatus 300 to display the work information inferred from the project information.

In the terminal apparatus 300 of the first embodiment, if the project information is input and the operation button 85 is selected on the screen 80, the screen 80 transitions to a screen 90 described below.

FIG. 9 is a diagram illustrating another display example of the terminal apparatus 300 of the first embodiment. The screen 90 illustrated in FIG. 9 is an example of the check screen displayed on the terminal apparatus 300 at step S712 in FIG. 7.

The screen 90 includes display areas 91, 92, 93, and 94 and operation buttons 95, 96, and 97. Each of the display areas 91 and 92 displays the attribute of the sender in the communication history information. In the first embodiment, the display area 91 displays the group of the sender “X Development Office” as the attribute of the sender in the communication history information. The display area 92 displays the group of the sender “Intellectual Property Development Section” as the attribute of the sender in the communication history information.

The display area 93 displays work names associated with the group “X Development Office” in the work information. The display area 94 displays work names associated with the group “Intellectual Property Development Section” in the work information.

The operation button 95 is for editing the work names displayed in the display area 93. The operation button 96 is for editing the work names displayed in the display area 94. If any of the operation buttons 95 and 96 is selected, the terminal apparatus 300 may display a screen for editing the work names displayed in the display area 93 or 94 corresponding to the selected one of the operation buttons 95 and 96.

The first embodiment thus enables the user of the terminal apparatus 300 to check the work names of each group inferred by the LLM 411. Even if there is an error in the work names inferred by the LLM 411, therefore, the work names of each group are correctable by the user of the terminal apparatus 300. Further, the first embodiment causes the terminal apparatus 300 to display, for each attribute of one or more members, a work inference result indicating the work inferred by the LLM 411. Thereby, the user of the terminal apparatus 300 is able to readily grasp the works of the project.

The operation button 97 is for issuing an instruction to generate a mind map. If the operation button 97 is operated on the screen 90, the terminal apparatus 300 transitions from the screen 90 to a screen 110 described below.

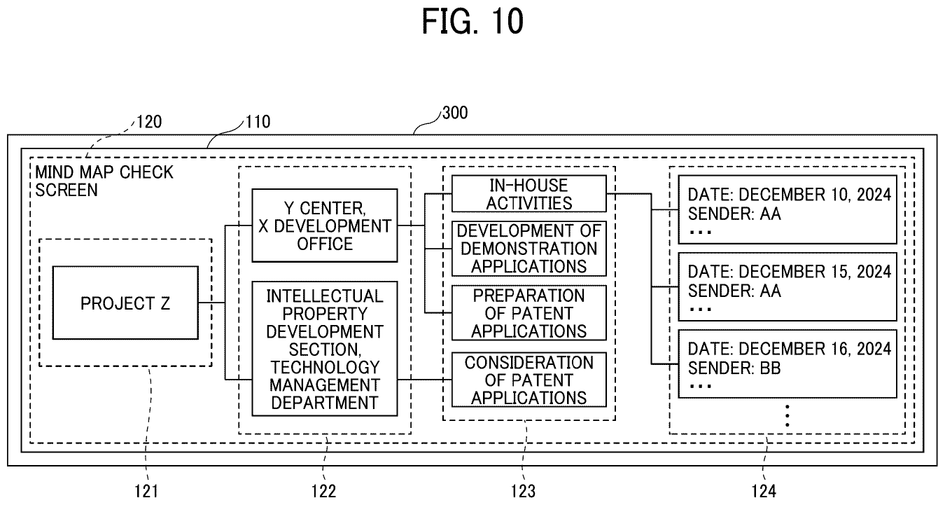

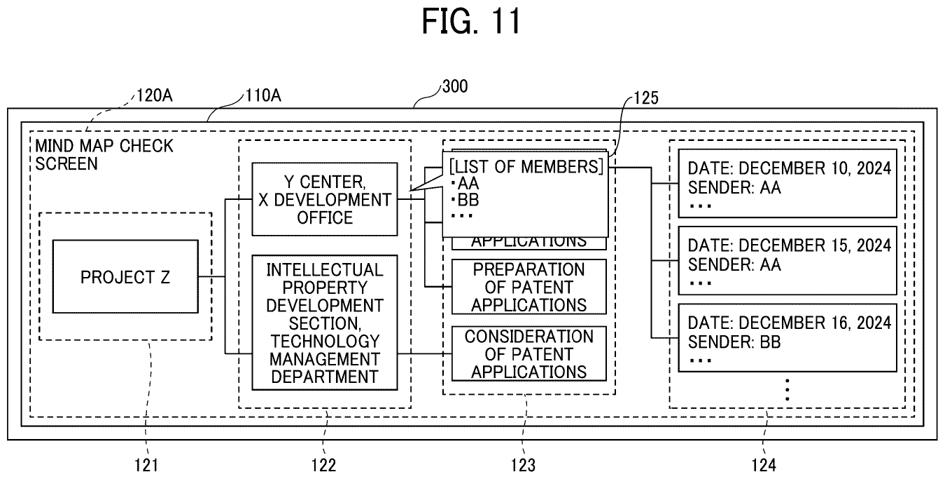

FIG. 10 is a diagram illustrating another display example of the terminal apparatus 300 of the first embodiment. The screen 110 illustrated in FIG. 10 is an example of a screen displayed on the terminal apparatus 300 at step S720 in FIG. 7. The screen 110 displays a mind map 120 represented by the mind map information generated by the idea generation support diagram generation unit 255.

The mind map 120 is a two-dimensional diagram including items: project name, the group of the sender, the work name, and the communication history information, which are associated with each other to form a hierarchy.

In the mind map 120, the project name is associated with the group of the sender, which is associated with the work name, which is associated with the communication history information.

In other words, the communication history information in the mind map 120 is sorted by the work name, which is sorted by the group of the sender, which is associated with the project name.

Therefore, the mind map 120 indicates that the item “project name” is the item of a top layer in the association between the items, and that the item “group” is the item of a second layer associated with the top layer. The mind map 120 also indicates that the item “work name” is the item of a third layer associated with the second layer, and that the item “communication history information” is the item of a fourth layer associated with the third layer.

In other words, in the association between the items in the mind map 120, the first attribute is the item of the second layer associated with the top layer, and the second attribute is the item of the third layer associated with the first attribute.

The mind map 120 illustrated in FIG. 10 includes display areas 121, 122, 123, and 124. The display area 121 displays the project name, which is the item of the top layer. The display area 122 displays the group of the sender, which is the item of the second layer. The display area 123 displays the work name, which is the item of the third layer. The display area 124 displays the communication history information, which is the item of the fourth layer.

The mind map 120 therefore indicates that the groups of the members participating in the project with the project name “Project Z” are Y Center of X Development Office and Intellectual Property Development Section of Technology Management Department. The mind map 120 also indicates that the work names indicating the works of the Y Center of X Development Office are in-house activities, the development of demonstration applications, and the preparation of patent applications, and that the work name indicating the work of the Intellectual Property Development Section of Technology Management Department is the consideration of patent applications.

The mind map 120 further indicates that the member with the name “AA,” who is assigned to Y Center of X Development Office and engaged in the in-house activities, has sent communication information related to the in-house activities.

The communication history information displayed in the display area 124 is communication history information associated with the group “Y Center, X Development Office” and the work name “in-house activities” in the communication history information extracted based on the project name. That is, the communication history information displayed in the display area 124 is communication history information sorted by the combination of the group of the sender and the work name indicating the work.

The information processing apparatus 200 thus generates the mind map information that sorts the communication history information based on the attribute of the sender of the communication information, and causes the terminal apparatus 300 to display the mind map 120 based on the mind map information.

The information processing apparatus 200 of the first embodiment further generates the mind map information that sorts the communication history information in accordance with the combination of the previously set first attribute and the second attribute inferred by the LLM 411 out of a plurality of attributes of the sender, and causes the terminal apparatus 300 to display the mind map information.

Specifically, the information processing apparatus 200 generates the mind map information that sorts the communication history information by the combination of the group of the sender and the work name indicating the work, and causes the terminal apparatus 300 to display the mind map information.

According to the first embodiment, therefore, in a project participated in by multiple members from different groups, the contents of information sent by each of the members are displayed in the mind map 120 as sorted by the group of the member and the work.

The mind map 120 therefore reflects the groups of the members and the work names, enabling the project manager in charge of tasks such as the progress management of the project to readily grasp the progress of various works included in the project. Further, the mind map 120 of the first embodiment displays the group and the works of the sender of the communication information in association with each other, which helps the project manager notice a high workload, for example. The first embodiment thus enables the project manager to readily grasp the progress of the works.

In the first embodiment, if an operation of selecting one of the groups of the senders displayed in the display area 122 is received on the screen 110, a list is displayed which includes the members assigned to the selected group out of the members participating in the project.

FIG. 11 is a diagram illustrating another display example of the terminal apparatus 300 of the first embodiment. In a screen 110A illustrated in FIG. 11, “Y Center, X Development Office” is selected from the groups displayed in the display area 122. The screen 110A displays a list 125 of members assigned to “Y Center, X Development Office” out of the members participating in the project.

In the first embodiment, a list of members participating in the project is thus displayed for each of the groups. Therefore, even if one of the members has not been communicating with the other members, for example, the project manager is able to know all members participating in the project by referring to a mind map 120A.

In the first embodiment, the terminal apparatus 300 is used mainly by the project manager, and the mind map is displayed on the terminal apparatus 300. However, this example does not limit the present disclosure. For example, the information processing system 100 may include terminal apparatuses used by the members participating in the project. In this case, the mind map is displayed on the terminal apparatuses used by the members participating in the project, allowing the members to grasp the progress of the project.

A second embodiment of the present disclosure will be described with reference to drawings.

The second embodiment is different from the first embodiment in receiving the selection of the item of the second layer in the mind map. The following description of the second embodiment will focus on differences from the first embodiment. Functions of the second embodiment similar to those of the first embodiment will be denoted with the same reference signs used in the first embodiment, and the description thereof will be omitted.

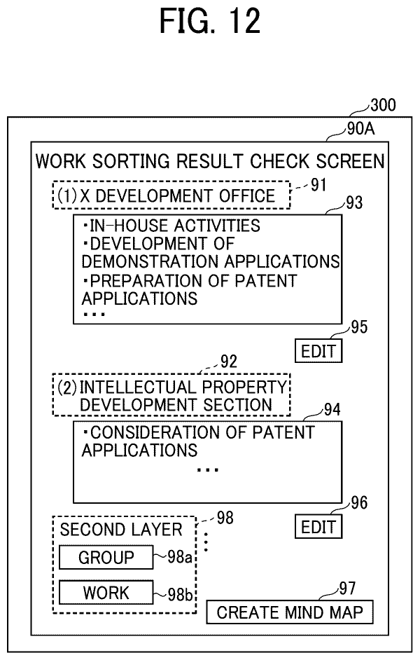

FIG. 12 is a diagram illustrating a display example of the terminal apparatus 300 of the second embodiment. A screen 90A illustrated in FIG. 12 is another example of the check screen displayed at step S712 in FIG. 7. The screen 90A of FIG. 12 is displayed on the terminal apparatus 300 based on screen information transmitted to the terminal apparatus 300 by the output unit 256 of a later-described information processing apparatus 200A.

The screen 90A includes operation buttons for selecting the item of the layer immediately below the top layer (i.e., the second layer).

The screen 90A includes operation buttons 98a and 98b. The operation button 98a is for setting the group of the sender as the item of the second layer in the mind map, i.e., for setting the first attribute of the sender as the item of the second layer in the mind map. The operation button 98b is for setting the work of the sender as the item of the second layer in the mind map, i.e., for setting the second attribute of the sender as the item of the second layer in the mind map.

If the operation button 97 is selected after the selection of the operation button 98a or 98b in a display area 98, the terminal apparatus 300 transmits the item associated with the selected operation button 98a or 98b to the information processing apparatus 200A together with the mind map generation request.

The second embodiment thus allows the project manager to select an item to be associated with the other items in the mind map.

The screen 90A illustrated in FIG. 12 is illustrative. In the second embodiment, it suffices if the operation of setting the second attribute as the item of the second layer in the mind map is executable. For example, the screen 90A may display the operation button 98b, but not the operation button 98a. Further, in the second embodiment, the first attribute as the item of the second layer in the mind map may be another item different from the item “group” and included in the attribute information stored in the attribute storage unit 240. In this case, the screen 90A may display, in place of the operation button 98a, an operation component for allowing the user to select, as the item of the first attribute, the another item in the attribute information stored in the attribute storage unit 240.

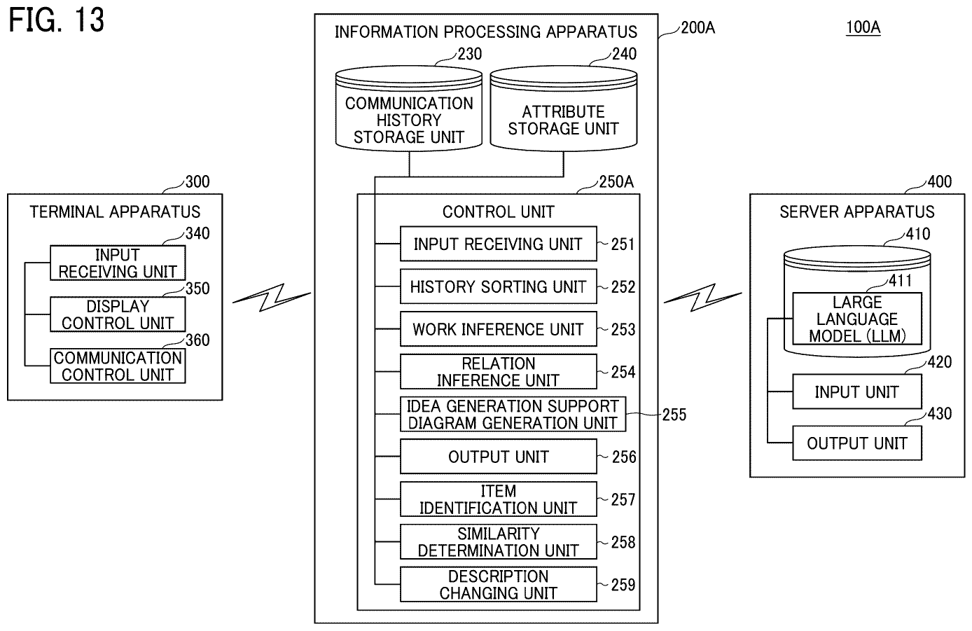

Functions of the information processing apparatus 200A included in an information processing system 100A of the second embodiment will be described below with reference to FIG. 13. FIG. 13 is a diagram illustrating functional configurations of the apparatuses included in the information processing system 100A.

In the information processing system 100A, the information processing apparatus 200A includes a control unit 250A. The control unit 250A of the second embodiment includes an item identification unit 257, a similarity determination unit 258, and a description changing unit 259 in addition to the units included in the control unit 250 of the first embodiment.

The item identification unit 257 identifies the item of the second layer based on the mind map generation request transmitted from the terminal apparatus 300.

If the work name as the second attribute is identified as the item of the second layer by the item identification unit 257, the similarity determination unit 258 determines whether the work information acquired by the work inference unit 253 includes work information items with similar work names.

If there are work information items with similar work names, the description changing unit 259 sets a single work name consolidating the similar work names and changes the similar work names of the work information items into the single consolidating work name. Details of the processes of the similarity determination unit 258 and the description changing unit 259 will be described later.

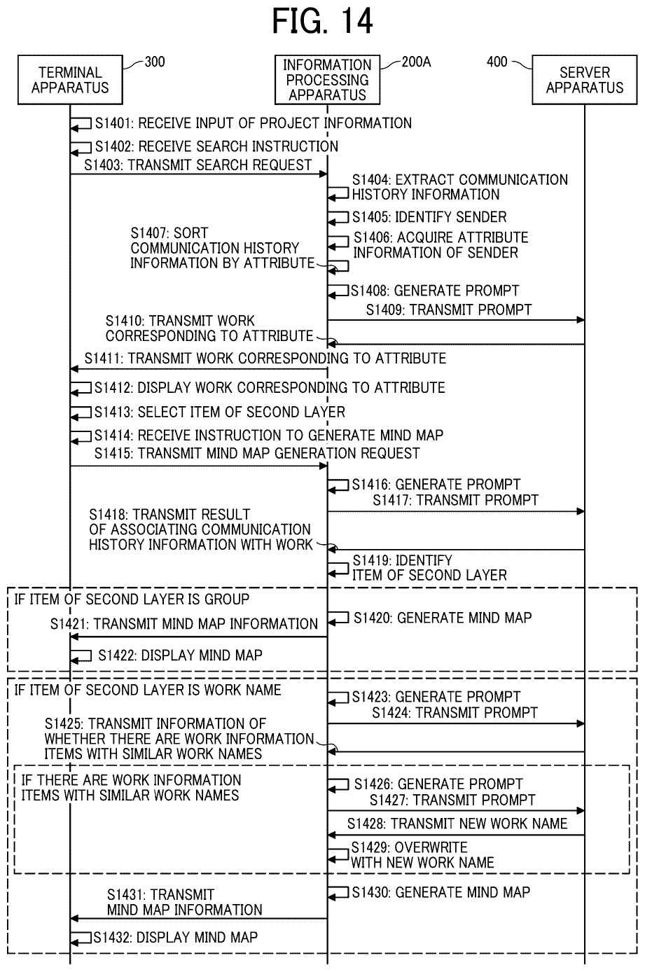

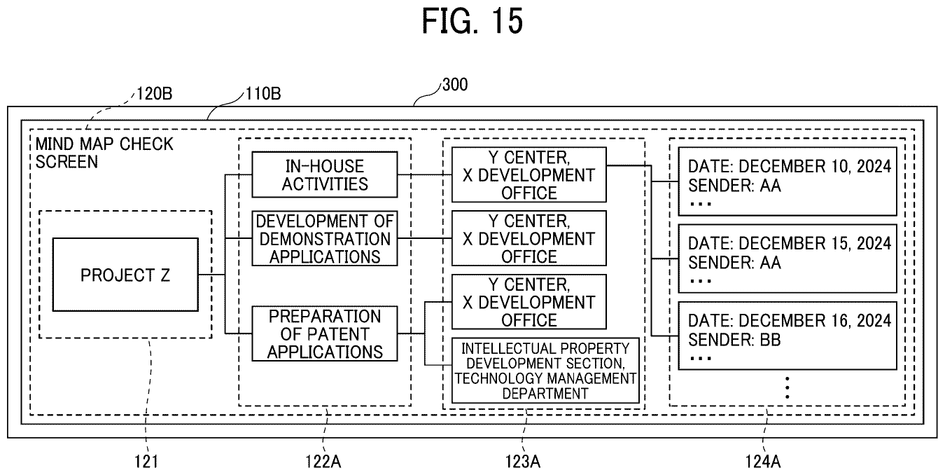

An operation of the information processing system 100A will be described with refence to FIG. 14. FIG. 14 is a sequence diagram illustrating an operation of the information processing system 100A of the second embodiment. The processes of steps S1401 to S1412 in FIG. 14 are similar to those of steps S701 to S712 in FIG. 7, and thus the description thereof will be omitted.

With the input receiving unit 340, the terminal apparatus 300 receives the selection of the item of the second layer in the mind map on the screen 90A (step S1413), and receives an operation of issuing an instruction to generate a mind map (step S1414). The terminal apparatus 300 then transmits to the information processing apparatus 200A a mind map generation request including the selected item of the second layer (step S1415).

The processes of steps S1416 to S1418 in FIG. 14 are similar to those of steps S715 to S717 in FIG. 7, and thus the description thereof will be omitted.

After step S1418, the item identification unit 257 of the information processing apparatus 200A identifies the item set for the second layer (step S1419).

If the item of the second layer identified at step S1419 is the group of the sender, the information processing apparatus 200A proceeds to step S1420. The processes of steps S1420 to S1422 in FIG. 14 are similar to those of steps S718 to S720 in FIG. 7, and thus the description thereof will be omitted.

If the item of the second layer identified at step S1419 is the work name, the similarity determination unit 258 of the information processing apparatus 200A generates a prompt requesting to determine whether the work information of the groups of the senders acquired at step S1410 includes work information items with similar work names (step S1423).

Then, the similarity determination unit 258 transmits the generated prompt to the server apparatus 400 (step S1424), and acquires from the server apparatus 400 determination result information indicating the result of determining whether the work information includes work information items with similar work names (step S1425).

In the server apparatus 400, in response to receipt of the prompt generated by the similarity determination unit 258, the input unit 420 inputs the prompt to the LLM 411, and the output unit 430 transmits response data output from the LLM 411 to the information processing apparatus 200A. The information processing apparatus 200A acquires the response data from the server apparatus 400 as the determination result information. Based on the determination result information, the similarity determination unit 258 determines the presence or absence of work information items with similar work names.

In the above-described example, the similarity determination unit 258 uses the LLM 411 to determine the presence or absence of work information items with similar work names. However, the determination method is not limited thereto. For example, the similarity determination unit 258 may calculate the degree of lexical similarity and the degree of semantic similarity between the work information items acquired at step S1410 and determine the presence or absence of work information items with similar work names based on the calculated degrees of similarity.

If the similarity determination unit 258 determines the absence of work information items with similar work names, the information processing apparatus 200A proceeds to step S1430, which will be described later.

If the similarity determination unit 258 determines the presence of work information items with similar work names, the description changing unit 259 of the information processing apparatus 200A generates a prompt requesting to create a new work name consolidating the similar work names (step S1426).

The description changing unit 259 then transmits the generated prompt to the server apparatus 400 (step S1427), and acquires a new work name from the server apparatus 400 (step S1428).

In the server apparatus 400, in response to receipt of the prompt generated by the description changing unit 259, the input unit 420 inputs the prompt to the LLM 411, and the output unit 430 transmits response data output from the LLM 411 to the information processing apparatus 200A. The information processing apparatus 200A acquires the response data from the server apparatus 400 as the new work name.

Then, the description changing unit 259 of the information processing apparatus 200A changes the similar work names of the work information items to the new work name acquired from the server apparatus 400 at step S1428 (step S1429), and proceeds to step S1430.

The processes of steps S1430 to S1432 in FIG. 14 are similar to those of steps S718 to S720 in FIG. 7, and thus the description thereof will be omitted.

The processes of the similarity determination unit 258 and the description changing unit 259 will be described in more detail. The following description will be given of a case in which first work information and second work information are acquired at step S1410. The first work information is work information that associates the group “Y Center, X Development Office” with the work name “preparation of patent applications.” The second work information is work information that associates the group “Intellectual Property Development Section, Technology Management Department” with the work name “consideration of patent applications.”

In this case, the similarity determination unit 258 generates a prompt requesting to determine whether the work name included in the first work information and the work name included in the second work information are similar to each other, and the output unit 256 transmits the generated prompt to the server apparatus 400. It is assumed here that the work names “preparation of patent applications” and “consideration of patent applications” in the determination result information acquired from the server apparatus 400 are determined to be similar (synonymous).

The description changing unit 259 generates a prompt requesting to create a work name consolidating the work names “preparation of patent applications” and “consideration of patent applications,” and the output unit 256 transmits the generated prompt to the server apparatus 400. The server apparatus 400 transmits a work name “patent-related work” to the information processing apparatus 200A as a new work name consolidating the two work names.

The description changing unit 259 changes the work name in the first work information, which associates the group “Y Center, X Development Office” with the work name “preparation of patent applications,” into the work name “patent-related work.” The description changing unit 259 further changes the work name in the second work information, which associates the group “Intellectual Property Development Section, Technology Management Department” with the work name “consideration of patent applications,” into the work name “patent-related work.” With this process, the group of the sender is associated with the new work name.

According to the second embodiment, therefore, if the work name is selected as the item of the second layer at step S1413, the user is able to review the relation between the group of the sender and the work name obtained at steps S1409 and S1410 before the selection of the item of the second layer.

A mind map of the second embodiment will be described with reference to FIG. 15. FIG. 15 is a diagram illustrating another display example of the terminal apparatus 300 of the second embodiment.

A screen 110B illustrated in FIG. 15 is an example of a screen displayed on the terminal apparatus 300 at step S1432 in FIG. 14. The screen 110B displays a mind map 120B.

The mind map 120B illustrated in FIG. 15 includes the display area 121 and display areas 122A, 123A, and 124A. In the mind map 120B, the work name is selected as the item of the second layer.

Therefore, the display area 122A for displaying the item of the second layer displays the work name associated with the group of the sender. The display area 123A displays the group of the sender associated with the work name displayed in the display area 122A. The display area 124A displays the communication history information of the group of the sender displayed in the display area 123A.

The second embodiment thus enables the user to specify the layer of an item to be associated with the other items in the mind map. The second embodiment therefore enables the project manager to display the mind map with the items associated differently depending on the situation.

A third embodiment of the present disclosure will be described with reference to drawings.

The third embodiment is different from the first embodiment in that the communication history information includes information identifying a member who has shared the communication information. In the following description of the third embodiment, functions similar to those of the first embodiment will be denoted with the same reference signs used in the first embodiment, and the description thereof will be omitted.

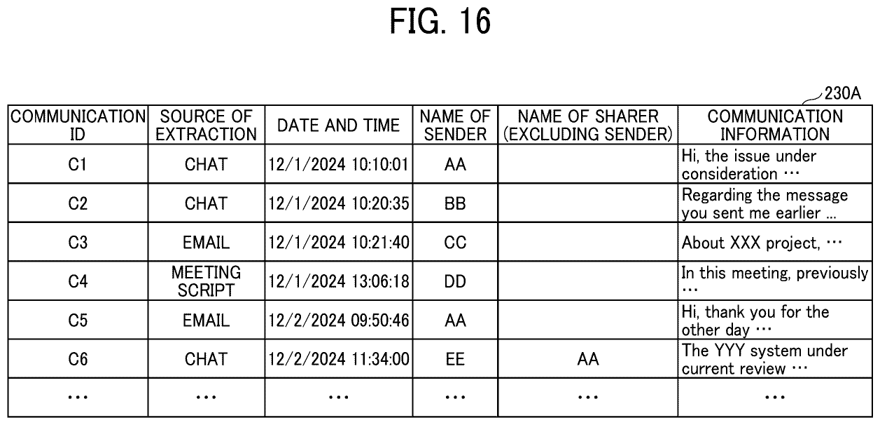

FIG. 16 is a table illustrating an example of a communication history storage unit 230A of the third embodiment. The communication history storage unit 230A illustrated in FIG. 16 includes an item “name of sharer” in addition to the information items of the communication history information stored in the communication history storage unit 230 illustrated in FIG. 5. The value of the item “name of sharer” is information identifying a member who has shared the communication information sent by the sender.

The sharer may be a member who has viewed a minute of a meeting held in relation to the project or a report prepared by a member participating in the project, a member who has received or viewed a chat message sent in a chat, or a member who has received an email, for example.

The operation of the information processing system 100 of the third embodiment is similar to that of the first embodiment illustrated in FIG. 7 except for identifying the sender and the sharer included in the communication history information at step S705 in FIG. 7, acquiring the attribute information of the sender and the attribute information of the sharer at step S706, and sorting the communication history information by the attribute of the sender and the attribute of the sharer at step S707, and thus the description thereof will be omitted.

In the sorting of the communication history information at step S707 in the third embodiment, communication history information items assigned with the same communication ID are sorted as different sorted information items; sorted information associated with the attribute of the sender and sorted information associated with the attribute of the sharer.

In other words, the sorted information of the third embodiment includes a plurality of sorted information items each including communication history information with the same communication ID.

In the third embodiment, the information identifying the sharer of the communication information is thus included in the communication history information, enabling the mind map to display the relationship between the sender and the sharer of the communication information.

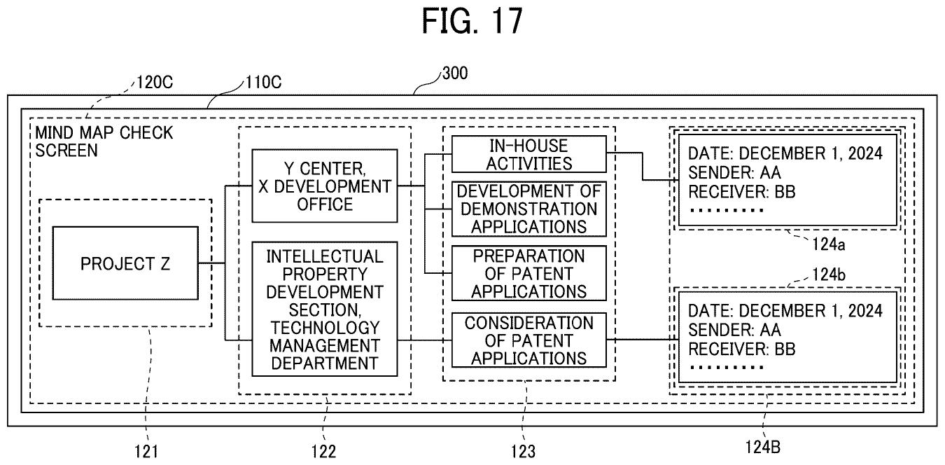

FIG. 17 is a diagram illustrating a display example of the terminal apparatus 300 of the third embodiment. A screen 110C illustrated in FIG. 17 is another example of the screen displayed on the terminal apparatus 300 at step S720 in FIG. 7. The screen 110C displays a mind map 120C.

The mind map 120C illustrated in FIG. 17 includes the display areas 121, 122, and 123 and a display area 124B. The display area 124B includes display areas 124a and 124b.

Each of the display areas 124a and 124b displays communication history information including communication information sent from a sender AA to a sharer (receiver) BB.

The communication history information displayed in the display area 124a is associated with the group of the sender in the sorted information. The communication history information displayed in the display area 124b has the same communication ID as that of the communication history information displayed in the display area 124a, and is associated with the group of the sharer in the sorted information.

In FIG. 17, the communication history information displayed in the display area 124a is associated with the work name “in-house activities” displayed in the display area 123. The work name “in-house activities” is associated with the group “Y Center, X Development Office” displayed in the display area 122. It is therefore understood that the communication history information displayed in the display area 124a is associated with the group “Y Center, X Development Office.”

Further, in FIG. 17, the communication history information displayed in the display area 124b is associated with the work name “consideration of patent applications” displayed in the display area 123. The work name “consideration of patent applications” is associated with the group “Intellectual Property Development Section, Technology Management Department” displayed in the display area 122. It is therefore understood that the communication history information displayed in the display area 124b is associated with the group “Intellectual Property Development Section, Technology Management Department.”

Thus, it is understood that the communication history information displayed in the display areas 124a and 124b in the mind map 120C indicates a history of communication between a member from the group “Y Center, X Development Office” with the work name “in-house activities” and a member from the group “Intellectual Property Development Section, Technology Management Department” with the work name “consideration of patent applications.”

According to the third embodiment, the sharer of the communication information is thus included in the communication history information, enabling the mind map to reflect both the sender and the sharer of the communication information. Therefore, the third embodiment enables the other members than the sharer assigned to the group of the sharer to access the communication information shared by the sharer, for example.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses described in the embodiments are only illustrative of one of several computing environments for implementing the embodiments disclosed herein.

In some embodiments, the information processing apparatus 200 includes a plurality of computing devices, e.g., a server cluster, that are configured to communicate with each other over any type of communications link, including a network, a shared memory, etc. to collectively perform the processes disclosed herein. Similarly, the information processing apparatus 200 can include a plurality of computing devices that are configured to communicate with each other.

Moreover, the information processing apparatus 200 can be configured to share the disclosed processing steps in various combinations. For example, the processes performed by a particular unit can be performed by the information processing apparatus 200. Similarly, the functionality of a particular unit can be performed by the information processing apparatus 200. Further, the components of the information processing apparatus 200 may be included in a single server apparatus or distributed to a plurality of apparatuses.

The information processing apparatus 200 may be any apparatus with a communication function. The information processing apparatus 200 may be, for example, an output device such as a projector (PJ), an interactive whiteboard (IWB; an electronic whiteboard having a blackboard function enabling mutual communication), or digital signage, or may be a head-up display (HUD), an industrial machine, an imaging device, a sound collecting device, a medical device, a networked home appliance, an automobile (connected car), a laptop personal computer (PC), a mobile phone, a smartphone, a tablet terminal, a game console, a personal digital assistant (PDA), a digital camera, a wearable PC, or a desktop PC.

The present disclosure has the following aspects, for example.

According to a first aspect, an information processing apparatus includes an input receiving unit, an identification unit, a history sorting unit, a work inference unit, and an output unit. The input receiving unit receives an input of project information. The identification unit identifies communication history information associated with a member participating in a project related to the received project information. The history sorting unit sorts the identified communication history information based on an attribute of the member. The work inference unit acquires a work inference result indicating a work of the member inferred by a large language model with the sorted communication history information. The output unit outputs the acquired work inference result in association with the attribute of the member.

According to a second aspect, in the information processing apparatus of the first aspect, the output unit outputs information representing an idea generation support diagram that sorts the communication history information in accordance with a combination of the attribute of the member and the work inference result.

According to a third aspect, in the information processing apparatus of the first or second aspect, the attribute of the member includes a first attribute and a second attribute. The first attribute is indicated by attribute information of the member. The second attribute is different from the first attribute and inferred based on the first attribute. The communication history information in the idea generation support diagram is sorted in accordance with the first attribute and the second attribute.

According to a fourth aspect, in the information processing apparatus of the third aspect, the first attribute is a group of the member included in the attribute information, and the second attribute is a work name indicating a work inferred based on the group of the member.

According to a fifth aspect, the information processing apparatus of one of the second to fourth aspects further includes a relation inference unit and an idea generation support diagram generation unit. The relation inference unit acquires association information that associates the work inference result with the attribute of the member based on a relation between the work inference result and the attribute of the member. The idea generation support diagram generation unit generates the information representing the idea generation support diagram with the association information. The idea generation support diagram sorts the communication history information in accordance with the combination of the attribute of the member and the work inference result. The output unit outputs the information representing the idea generation support diagram generated by the idea generation support diagram generation unit.

According to a sixth aspect, in the information processing apparatus of the fifth aspect, the idea generation support diagram is a two-dimensional diagram with a plurality of items including a project name included in the project information, the attribute of the member, the work inference result, and the communication history information. The plurality of items are associated with each other to form a hierarchy including a top layer, a second layer associated with the top layer, a third layer associated with the second layer, and a fourth layer associated with the third layer. The idea generation support diagram generation unit generates the information representing the idea generation support diagram with the project name set as an item of the top layer, the attribute of the member set as an item of the second layer, the work inference result set as an item of the third layer, and the communication history information set as an item of the fourth layer.

According to a seventh aspect, in the information processing apparatus of the fifth or sixth aspect, the idea generation support diagram is a two-dimensional diagram with a plurality of items including a project name included in the project information, the attribute of the member, the work inference result, and the communication history information. The plurality of items are associated with each other to form a hierarchy including a top layer, a second layer associated with the top layer, a third layer associated with the second layer, and a fourth layer associated with the third layer. The idea generation support diagram generation unit generates the information representing the idea generation support diagram with the project name set as an item of the top layer, the work inference result set as an item of the second layer, the attribute of the member set as an item of the third layer, and the communication history information set as an item of the fourth layer.

According to an eighth aspect, in the information processing apparatus of the sixth or seventh aspect, the output unit outputs screen information of a screen for receiving selection of the item of the second layer.

According to a ninth aspect, in the information processing apparatus of one of the fifth to eighth aspects, the work inference unit generates a prompt requesting to infer the work of the member with the sorted communication history information, outputs the generated prompt to the large language model, and acquires response data output from the large language model as the work inference result.

According to a tenth aspect, in the information processing apparatus of one of the fifth to ninth aspects, the relation inference unit generates a prompt requesting to associate the communication history information with the work inference result, outputs the generated prompt to the large language model, and acquires response data output from the large language model as the association information.

According to an eleventh aspect, an information processing method performed by an information processing apparatus includes receiving an input of project information, identifying communication history information associated with a member participating in a project related to the received project information, sorting the identified communication history information based on an attribute of the member, acquiring a work inference result indicating a work of the member inferred by a large language model with the sorted communication history information, and outputting the acquired work inference result in association with the attribute of the member.

According to a twelfth aspect, a non-transitory recording medium stores a plurality of instructions which, when executed by one or more processors of an information processing apparatus, causes the one or more processors to perform a process of receiving an input of project information, identifying communication history information associated with a member participating in a project related to the received project information, sorting the identified communication history information based on an attribute of the member, acquiring a work inference result indicating a work of the member inferred by a large language model with the sorted communication history information, and outputting the acquired work inference result in association with the attribute of the member.

According to a thirteenth aspect, an information processing system includes an information processing apparatus and a terminal apparatus that communicates with the information processing apparatus via a network. The information processing apparatus includes an input receiving unit, an identification unit, a history sorting unit, a work inference unit, and an output unit. The input receiving unit receives an input of project information. The identification unit identifies communication history information associated with a member participating in a project related to the received project information. The history sorting unit sorts the identified communication history information based on an attribute of the member. The work inference unit acquires a work inference result indicating a work of the member inferred by a large language model with the sorted communication history information. The output unit outputs the acquired work inference result in association with the attribute of the member. The terminal apparatus includes a display control unit that causes a display unit to display the work inference result in association with the attribute of the member.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus comprising circuitry configured to
receive an input of project information,
identify communication history information associated with a member participating in a project related to the received project information,
sort the identified communication history information based on an attribute of the member,
acquire a work inference result indicating a work of the member inferred by a large language model with the sorted communication history information, and
output the acquired work inference result in association with the attribute of the member.

2. The information processing apparatus of claim 1, wherein the circuitry outputs information representing an idea generation support diagram that sorts the communication history information in accordance with a combination of the attribute of the member and the work inference result.

3. The information processing apparatus of claim 2, wherein the attribute of the member includes a first attribute indicated by attribute information of the member and a second attribute different from the first attribute and inferred based on the first attribute, and
wherein the communication history information in the idea generation support diagram is sorted in accordance with the first attribute and the second attribute.

4. The information processing apparatus of claim 3, wherein the first attribute is an affiliation of the member included in the attribute information, and
wherein the second attribute is a work name indicating a work inferred based on the group of the member.

5. The information processing apparatus of claim 4, wherein the circuitry
acquires association information that associates the work inference result with the attribute of the member based on a relation between the work inference result and the attribute of the member,
generates the information representing the idea generation support diagram with the association information, and
outputs the generated information representing the idea generation support diagram.

6. The information processing apparatus of claim 5, wherein the idea generation support diagram is a two-dimensional diagram with a plurality of items including a project name included in the project information, the attribute of the member, the work inference result, and the communication history information, the plurality of items being associated with each other to form a hierarchy including a top layer, a second layer associated with the top layer, a third layer associated with the second layer, and a fourth layer associated with the third layer, and
wherein the circuitry generates the information representing the idea generation support diagram with the project name set as an item of the top layer, the attribute of the member set as an item of the second layer, the work inference result set as an item of the third layer, and the communication history information set as an item of the fourth layer.

7. The information processing apparatus of claim 5, wherein the idea generation support diagram is a two-dimensional diagram with a plurality of items including a project name included in the project information, the attribute of the member, the work inference result, and the communication history information, the plurality of items being associated with each other to form a hierarchy including a top layer, a second layer associated with the top layer, a third layer associated with the second layer, and a fourth layer associated with the third layer, and
wherein the circuitry generates the information representing the idea generation support diagram with the project name set as an item of the top layer, the work inference result set as an item of the second layer, the attribute of the member set as an item of the third layer, and the communication history information set as an item of the fourth layer.

8. The information processing apparatus of claim 6, wherein the circuitry outputs screen information of a screen for receiving selection of the item of the second layer.

9. The information processing apparatus of claim 1, wherein the circuitry
generates a prompt requesting to infer the work of the member with the communication history information sorted based on the attribute of the member,
outputs the generated prompt to the large language model, and
acquires response data output from the large language model as the work inference result.

10. The information processing apparatus of claim 5, wherein the circuitry
generates a prompt requesting to associate the communication history information with the work inference result,
outputs the generated prompt to the large language model, and
acquires response data output from the large language model as the association information.

11. An information processing method comprising:
receiving an input of project information;
identifying communication history information associated with a member participating in a project related to the received project information;
sorting the identified communication history information based on an attribute of the member;
acquiring a work inference result indicating a work of the member inferred by a large language model with the sorted communication history information; and
outputting the acquired work inference result in association with the attribute of the member.

12. An information processing system comprising:
an information processing apparatus; and
a terminal apparatus to communicate with the information processing apparatus via a network,
the information processing apparatus including first circuitry configured to
receive an input of project information,
identify communication history information associated with a member participating in a project related to the received project information,
sort the identified communication history information based on an attribute of the member,
acquire a work inference result indicating a work of the member inferred by a large language model with the sorted communication history information, and
output the acquired work inference result in association with the attribute of the member, and
the terminal apparatus including second circuitry configured to display the work inference result on a display in association with the attribute of the member.
